(19) United States
(12) Patent Application Publication
(10) Pub. No.: US 2007/0075623 A1
(43) Pub. Date: Apr. 5, 2007

(54) Electron emission display device and method of making the same

(76) Inventors: Su-Kyung Lee, Chunan-si (KR); Seung-Joon Yoo, Chunan-si (KR); Zin-Min Park, Chunan-si (KR); Soo-Joung Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/540,542

(22) Filed: Oct. 2, 2006

(30) Foreign Application Priority Data
Sep. 30, 2005 (KR) 10-2005-0091955

(51) Int. Cl. H01J 63/04; H01J 1/62

(52) U.S. Cl. 313/496

(57) ABSTRACT

A method of making an electron emission display device having an electron emission unit and a light emission unit, wherein forming the light emission unit includes forming a black layer pattern on a substrate, printing a first phosphor pattern using a first phosphor paste, printing a second phosphor pattern using a second phosphor paste, and printing a third phosphor pattern using a third phosphor paste, wherein the each of the first, second and third phosphor pastes includes, respectively, first, second and third phosphor materials that are surface-treated with a same surface treatment.

### BACKGROUND OF THE INVENTION

1. Field of the Invention

The present invention relates to an electron emission display device and a method of making the same. More particularly, the present invention relates to an electron emission display device that may employ a variety of phosphor materials and a method of making the electron emission display device that is compatible with the variety of phosphor materials in order to provide an electron emission display device with excellent brightness and color reproduction using phosphors with excellent photoluminescent brightness and color purity.

2. Description of the Related Art

Generally, electron emission display devices are display devices, e.g., flat panel display devices, televisions, monitors, etc., that employ an electron emission display panel to display images. Electron emission display devices may be classified by the type of electron emission display panel employed. Types of electron emission display panels may include a first type in which a hot cathode is used as an electron emission source and a second type in which a cold cathode is used as the electron emission source. The second type of electron emission display panel may be further classified as a field emitter array (FEA) type, a surface conduction emission (SCE) type, a metal-insulator-metal (MIM) type and a metal-insulator-semiconductor (MIS) type. Each of these types of electron emission display panels may include a pair of opposing substrates that form an electron emission unit and a light emission unit, wherein the electron emission unit may generate a controlled electron emission and the light emission unit may emit visible light upon stimulation by electrons emitted from the electron emission unit.

### SUMMARY OF THE INVENTION

The present invention is therefore directed to an electron emission display device and a method of making the same, which substantially overcome one or more of the problems due to the limitations and disadvantages of the related art.

It is therefore a feature of an embodiment of the present invention to provide an electron emission display device and a method of making the same that provide excellent brightness and color reproduction by using phosphors with excellent photoluminescent brightness and color purity.

It is therefore another feature of an embodiment of the present invention to provide a method of making an electron emission display device that is simple and compatible with a variety of phosphor materials.

At least one of the above and other features and advantages of the present invention may be realized by providing a method of making an electron emission display device having an electron emission unit and a light emission unit, wherein forming the light emission unit includes forming a black layer pattern on a substrate, printing a first phosphor pattern using a first phosphor paste, printing a second phosphor pattern using a second phosphor paste, and printing a third phosphor pattern using a third phosphor paste, wherein the each of the first, second and third phosphor pastes includes, respectively, first, second and third phosphor materials that are surface-treated with a same surface treatment.

The first phosphor paste may be a red phosphor paste, the second phosphor paste may be a green phosphor paste and the third phosphor paste may be a blue phosphor paste. At least one phosphor material may include SrGa₂S₄:Eu. Each of the first, second and third phosphor materials may be surface-treated with SiO₂.The surface treatment may include preparing a SiO₂ solution from SiO₂ particles, and mixing the SiO₂ solution with the respective phosphor material to form a mixture. The mixture may include a weight of SiO₂ in a range of about 0.01 to about 20%, based on the weight of the phosphor material in the mixture. The mixture may include a weight of SiO₂ in a range of about 1 to about 10%, based on the weight of the phosphor material in the mixture. The SiO₂ particles may have an average particle size in a range of about 1 nm to about 100 nm.

Printing the first, second and third phosphor patterns may include applying the first, second and third phosphor pastes only in locations corresponding to respective first, second and third phosphor layers. The first, second and third phosphor patterns may be printed using a print head. The black layer pattern may include a plurality of voids corresponding to pixel regions, and the first, second and third phosphor patterns may be printed in the voids. The method may further include firing the phosphor patterns at a temperature in a range of about 400° C. to about 480° C.

At least one of the above and other features and advantages of the present invention may also be realized by providing a flat panel display panel including an energy emission unit, and a light emission unit disposed to face the energy emission unit, wherein the light emission unit includes a black layer pattern on a substrate, a first phosphor pattern, a second phosphor pattern, and a third phosphor pattern, wherein the each of the first, second and third phosphor patterns includes, respectively, first, second and third phosphor materials that are surface-treated with a same surface treatment.

The first, second and third phosphor patterns may be red, green and blue phosphor patterns, respectively. The energy emission unit may be an electron emission unit. At least one phosphor pattern may include SrGa₂S₄:Eu. The first, second and third phosphor materials may be surface-treated with SiO₂.

At least one of the above and other features and advantages of the present invention may further be realized by providing an electron emission display panel including an electron emission unit and a light emission unit disposed to face the electron emission unit, wherein the light emission unit includes a SrGa₂S₄:Eu phosphor layer.

The SrGa₂S₄:Eu phosphor layer may include SiO₂.

### BRIEF DESCRIPTION OF THE DRAWINGS

The above and other features and advantages of the present invention will become more apparent to those of ordinary skill in the art by describing in detail exemplary embodiments thereof with reference to the attached drawing in which:

FIG. 1 illustrates an exploded perspective view of an electron emission display panel according to an embodiment of the present invention;

FIG. 2 illustrates a flow chart of a method of making an electron emission display device according to an embodiment of the present invention; and

FIG. 3 illustrates a flow chart of a method of making a light emission unit of an electron emission display panel according to an embodiment of the present invention.

### DETAILED DESCRIPTION OF THE INVENTION

Korean Patent Application No. 10-2005-0091955, filed on Sep. 30, 2005, in the Korean Intellectual Property Office, and entitled: “A METHOD OF MAKING AN ELECTRON EMISSION DISPLAY DEVICE,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in-the art. In the figures, the dimensions of layers and regions are exaggerated for clarity of illustration.

It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. It will also be understood that the term “phosphor” is intended to generally refer to a material that can generate visible light upon excitation by electrons that impinge thereon, and is not intended be limited to materials the undergo light emission through any particular mechanism or over any particular time frame. Like reference numerals refer to like elements throughout.

The present invention relates to an electron emission display device that may employ a variety of phosphor materials and a method of making the electron emission display device that is compatible with the variety of phosphor materials. The electron emission display device may include a light emission unit having plurality of phosphor layers, e.g., red, green and blue phosphor layers, wherein one or more of the phosphor layers is formed by surface treating the respective phosphor material, forming a phosphor paste from the surface-treated phosphor material and directly pattern printing the phosphor paste in a predetermined pattern. Each of the phosphor materials may be surface treated with a same surface treatment agent. The surface-treated phosphor materials may exhibit stable storage characteristics, allowing the surface-treated phosphor materials to remain useful for a long time during the manufacturing process. Furthermore, preparing each of the phosphor materials using the same surface treatment agent may simplify the manufacturing process.

The surface treatment may include applying silicon dioxide (SiO₂) to the phosphor material, such that particles of the phosphor material have SiO₂ attached on the surface thereof. The surface treatment may stabilize the phosphor material, thereby maintaining the stability of the phosphor paste used to form the phosphor layer and allowing for extended storage thereof. The green phosphor material may be SrGa₂S₄:Eu, which exhibits excellent brightness and color reproduction.

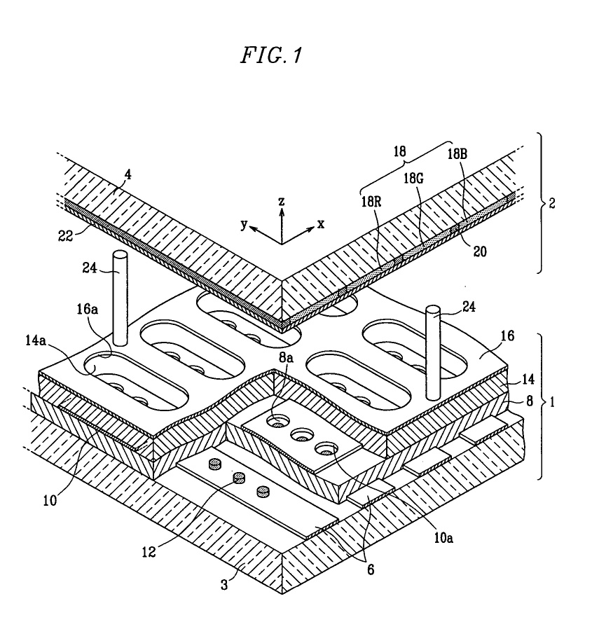

FIG. 1 illustrates an exploded perspective view of an electron emission display panel according to an embodiment of the present invention. The electron emission display device may include an electron emission unit 1 and a light emission unit 2. In describing embodiments of the present invention, a particular example of a FEA type electron emission display panel will be described. However, the structure of the electron emission unit is not limited to that illustrated, and may be altered in various manners. Moreover, those of ordinary skill in the art will appreciate that the present invention may be implemented in other types of display panels including, e.g., SCE, MIM and MIS types, as well as other types of flat panels.

The electron emission unit 1 and the light emission unit 2 may be arranged to face each other and may be spaced apart to define an inner space therebetween. Edges of the units 1 and 2 may be sealed to one another and the inner space may be evacuated. The electron emission unit 1 may emit electrons, which may impinge on the light emission unit 2, thereby causing the light emission unit 2 to emit visible light, e.g., a displayed image.

The electron emission unit 1 may include a first substrate 3. First electrodes 6, e.g., cathode electrodes, may be disposed in a striped pattern on the first substrate 3. The first electrodes 6 may be oriented parallel to each other and may extend in parallel with the major plane of the first substrate 3, e.g., in the direction of the y axis as illustrated in FIG. 1. A first insulating layer 8 may cover the surface of the first substrate 3 and the first electrodes 6. Second electrodes 10, e.g., gate electrodes, may be disposed in a striped pattern on the first insulating layer 8. The second electrodes 10 may extend in parallel with the major plane of the first substrate 3 and may be oriented perpendicular to the first electrodes 6, e.g., in the direction of the x axis as illustrated in FIG. 1.

The crossed or intersecting areas of the first electrodes 6 and the second electrodes 10 may define pixel areas. One or more electron emission regions 12 may be formed on the first electrodes 6 at each pixel area. As illustrated, the second electrodes 10, e.g., the gate electrodes, may be disposed over the first electrodes 6, e.g., the cathode electrodes, with the first insulating layer 8 interposed therebetween. That is, the second electrodes 10 may be closer to the light emission unit 2 than the first electrodes 6 are. However, in another implementation, the first electrodes 6, e.g., the cathodes, may be disposed over the second electrodes 10, e.g., the gate electrodes, in which case the electron emission regions 12 may be configured to contact a lateral side of the first electrodes 6 on the first insulating layer 8 (not shown).

The electron emission regions 12 may be of various suitable sizes and shapes, e.g., circular or cylindrical, flat-topped, etc., and one or more electron emission regions 12, e.g., three, may be arranged in each pixel area. The electron emission regions 12 may be arranged in, e.g., a linear pattern oriented in the direction of the corresponding first electrode 6.

The electron emission regions 12 may be formed of a material that emits electrons under the application of an electric field, e.g., a carbonaceous material, a nanometer-sized material (i.e., having a size of about 1 to about 1000 nm), etc. Exemplary electron emission region materials may include carbon nanotubes, graphite, graphite nanofiber, diamond, diamond-like carbon, fullerene (C₆₀), silicon nanowire, combinations thereof, etc.

Openings 8a and 10a may be positioned in the first insulating layer 8 and the second electrodes 10, respectively, at locations corresponding to the respective electron emission regions 12, thereby exposing the electron emission regions 12 to the inner space defined between the electron emission unit 1 and the light emission unit 2.

A second insulating layer 14 and a third electrode 16, e.g., a focusing electrode, may cover the second electrodes 10 and the first insulating layer 8. The third electrode 16 may cover the second insulating layer 14 and may be formed as a single monolithic layer or as a series of distinct portions that correspond to the pixel regions. The third electrode may be one or more conductive layers, a metal plate, etc.

Openings 14a and 16a may be positioned in the second insulating layer 14 and the third electrode 16, respectively, at locations corresponding to the pixel areas in order to expose the electron emission regions 12 to the inner space defined between the electron emission unit 1 and the light emission unit 2. The third electrode 16 may be a focusing electrode that gathers electrons emitted from each pixel region. The focusing effect may be enhanced as a distance between the focusing electrode and the electron emission regions 12 increases. Therefore, it may be desirable to increase the thickness of the second insulating layer 14, e.g., to a thickness greater than that of the first insulating layer 8.

In the light emission unit 2, one or more black layers 20 may be formed on the lower surface of the second substrate 4, i.e., the surface of the second substrate 4 that faces to the electron emission unit 1. The second substrate 4 may be formed of a transparent material, e.g., glass. The black layers 20 may enhance screen contrast by reducing reflection of external light from regions between phosphor layers 18. The black layers 20 may be formed from a black layer composition that includes, e.g., carbon materials such as graphite, metal-based materials such as chromium oxide, indium, tin, indium-tin, copper, antimony, titanium, manganese, cobalt, nickel, zinc, lead, chromium, etc., and a dielectric material, e.g., SiO, SiO₂, MgF₂, SiNₓ (where x is an integer of greater than 1), etc.

The phosphor layers 18 may be disposed at predetermined intervals on a lower surface of the second substrate 4 between the black layers 20. The phosphor layers 18 may include, e.g., red (18R), green (18G) and blue (18B) phosphor layers spaced apart at predetermined intervals. In FIG. 1, the phosphor layers 18 and the black layers 20 are illustrated as being arranged in a striped pattern, but the phosphor layers 18 may be individually provided at the respective pixel areas, while the black layers 20 may be provided at non-light-emitting areas, i.e., in areas that do not have the phosphor layers 18.

The phosphor layers 18 may include surface-treated phosphor materials, e.g., phosphor materials having SiO₂ attached on the surfaces thereof. The phosphor materials may be any one of a variety of red, green, blue, etc., colored phosphors including, e.g., red phosphor materials such as Y₂O₂S:Eu, Y₂O₃:Eu, YVO₄:Eu, Y(V,P)O₄:Eu,(Y,Gd)BO₂:Eu, SrTiO₃:Pr and mixtures thereof, blue phosphor materials such as SrGa₂S₄:Ce, ZnS:Ag, Y₂SiO₅:Ce, Sr₅(PO₄)₃Cl:Eu, ZnS:Ag, BaMgAl₁₀O₁₇:Eu and mixtures thereof, and various green phosphor materials. In particular, the green phosphor material may be SrGa₂S₄:Eu, which exhibits excellent brightness and color reproduction, and which is not conventionally used in electron emission display devices. In particular, conventional methods of making electron emission display devices have proven to be unsatisfactory for use with SrGa₂S₄:Eu, as will be explained in additional detail below.

An anode 22 may be disposed on the phosphor layers 18 and the black layers 20. The anode 22 may include, e.g., a metal layer or thin film such as aluminum. During operation of the electron emission display device, the anode 22 may have a high voltage applied thereto in order to accelerate the electron beams from the electron emission unit 1. The anode 22 may also reflect any visible light that is emitted by the phosphor layers 18 towards the first substrate 3 back through the second substrate 4, thereby increasing the screen brightness of the electron emission display device.

In another implementation (not shown), the anode may include a transparent conductive material, e.g., indium tin oxide (ITO), in which case the anode may be placed on the upper surface of the phosphor layers 18 and the black layers 20, i.e., so that the phosphor layers 18 and the black layers 20 are disposed between the transparent anode and the electron emission unit 1. The transparent anode may be patterned in a plurality of portions.

Spacers 24 may be disposed between the electron emission unit 1 and the light emission unit 2 in order to maintain a predetermined space therebetween. The spacers 24 may be arranged to correspond to non-light-emitting areas, e.g., where the black layers 20 are positioned. The electron emission display panel may be formed by coupling the electron emission unit 1 and the light emission unit 2 and sealing the edges, using e.g., a glass frit disposed along the periphery and evacuating the space defined between the electron emission unit 1 and the light emission unit 2, so as to maintain a vacuum therein.

The electron emission display panel may be mounted to a chassis and coupled to driving circuits, and then placed in a housing (not shown). The housing may include various other components, e.g., heat dissipating components such as heat sinks, fans, etc., filters such as infrared (IR) filters, etc. (not shown).

An electron emission display device with the aforementioned structure may be operated by supplying respective driving voltages to the cathode 6, the gate electrode 10, the focusing electrode 16 and the anode 22. For example, either of the cathode 6 and the gate electrode 10 may have a scanning signal voltage applied thereto with the other electrode having a data signal voltage applied thereto. The focusing electrode 16 may have a driving voltage of tens of volts of negative (−) direct current voltage applied thereto and the anode 22 may have a driving voltage of hundreds to thousands of volts of positive (+) direct current voltage applied thereto.

During operation, pixels with a voltage difference between the cathodes 6 and the gate electrodes 10 that is beyond a critical point may form a field emission around an electron emission region 12, thereby emitting electrons. The electrons may pass through an opening 16a in the focusing electrode 16 and may be concentrated or collated due to the repulsive force exhibited by the negatively charged focusing electrode 16 on the negatively charged electrons. Thereafter, the electrons may be attracted by the high positive voltage applied to the anode 22, causing them to collide with a corresponding phosphor layer 18, which, in turn, emits visible light.

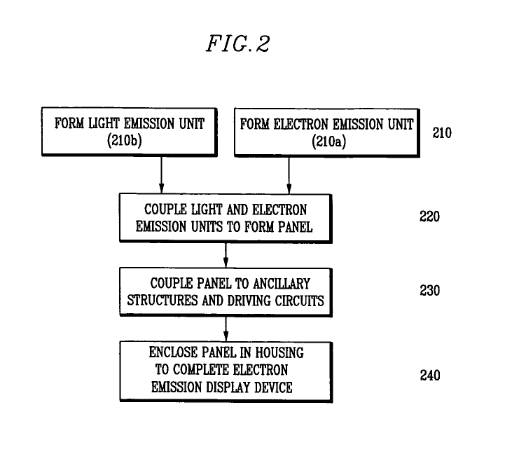

FIG. 2 illustrates a flow chart of a method of making an electron emission display device according to an embodiment of the present invention. Referring to FIG. 2, the electron emission unit 1 and the light emission unit 2 may be fabricated in processes 210a and 210b, respectively. Fabrication of the electron emission unit 1 in process 210a may include providing the first substrate 1 and forming the first electrodes 6 on the first substrate. The first substrate 1 and the first electrodes 6 may be covered with the first insulating layer 8. The second electrodes 10 may be formed on the first insulating 8 and the covering the second electrodes 10 and the first insulating layer 8 with the second insulating layer 14. A third electrode 16 may be formed on the second insulating layer 14. Openings 8a, 10a, 14a and 16a may be formed in locations corresponding to the pixel areas defined by the intersection of the first and second electrodes 6 and 8. The electron emission units 12 may be formed on the first electrodes 6. The electron emission units 12 may be formed using, e.g., screen printing, direct growth, chemical vapor deposition, sputtering, etc. Fabrication of the light emission unit in process 210b is described in detail below.

The electron emission unit 1 and the light emission unit 2 may be aligned, evacuated and sealed together to form an electron emission display panel in process 220. The electron emission display panel may be coupled to ancillary structures such as a chassis, heat dissipation components, etc., and coupled to one or more driving circuits, e.g., an integrated circuit chip disposed on a printed circuit board, in process 230. The electron emission display panel, ancillary structures and driving circuits may be enclosed in a housing to complete the electron emission display device in process 240.

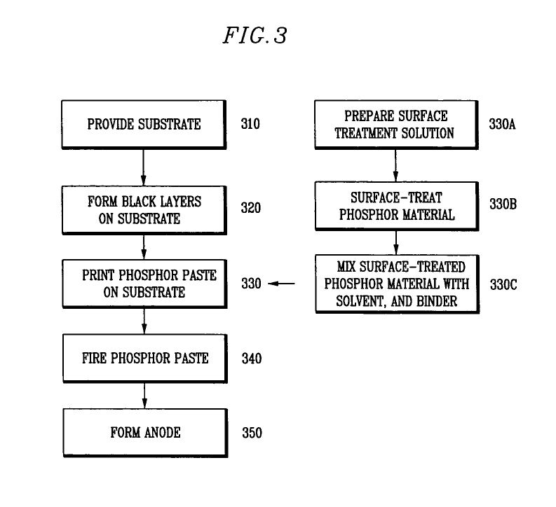

FIG. 3 illustrates a flow chart of a method of making a light emission unit of an electron emission display panel in accordance with an embodiment of the present invention. Referring to FIG. 3, fabrication of the light emission unit may include providing the second substrate 4, which may be, e.g., a transparent material such as glass, in operation 310. One or more black layers 20 may be formed on the second substrate 4 in operation 320. The black layers 20 may be formed using a black layer composition through processes such as electrophoresis, screen printing, spin coating, etc.

Phosphor layers 18 may be formed between the black layers 20 in operation 330. The anode 22 may be formed on the phosphor layers 18 and the black layers 20 in operation 350. In another implementation (not shown), the anode may be formed before the phosphor layers 18 and the black layers 20, in which case the anode 22 may be formed of a transparent material.

In operation 330, the phosphor layers 18 may be formed by printing a phosphor paste. That is, for example, phosphor layers 18R, 18G and 18B may be formed by printing red, green and blue phosphor pastes, respectively. The printing process for printing the red, green and blue phosphor pastes may be a pattern printing process wherein each of the red, green and blue phosphor pastes is applied only where it is supposed to be.

That is, each phosphor paste may be directly printed only where the resultant phosphor layers 18R, 18G and 18B are disposed, in contrast to, e.g., a spin-coating process whereby a phosphor slurry is spread across the entire surface of the substrate, patterned with a mask and then developed to remove undesired phosphor from the substrate. Directly printing each phosphor paste may include using a print head to print phosphor paste patterns on the second substrate 4.

After printing the phosphor paste, the phosphor paste may be fired in operation 340. The firing may be performed at about 400° C. to about 480° C. If the temperature is higher than about 480° C., the resultant phosphor layer may have a reduced efficiency, while if the temperature is lower than about 400° C., problems may arise as a result of residual carbon.

The phosphor paste may be formed by mixing a surface-treated phosphor material, e.g., a surface-treated red, green or blue phosphor material, with a solvent and a binder in operation 330C. The solvent may include, e.g., butylcarbitol acetate (2-(2-butoxyethoxy)ethyl acetate) or terpineol (3-cyclohexene-1-methanol), and the binder may include, e.g., ethyl cellulose.

The surface treatment of each of the red, green and blue phosphor materials may include surface treatment with SiO₂ in operation 330B. That is, the surface-treated red, green and blue phosphor materials may each include the respective red, green or blue phosphor material and SiO₂ coating layers formed on the surface of the phosphor material particles.

The surface treatment may be performed by preparing a SiO₂ solution in operation 330A by mixing or suspending SiO₂ in an appropriate agent, e.g., water, alcohols such as methanol, ethanol, butanol, propanol, isopropanol and mixtures thereof, and adding the respective red, green or blue phosphor material to the SiO₂ solution and mixing them. The SiO₂ may have an average particle size in the nanometer range, i.e., about 1 nm to about 1000 nm. More particularly, the SiO₂ particles may have an average particle size in the range of about 1 nm to about 100 nm. If the SiO₂ has an average particle size of less than about 1 nm, the attachment effects thereof may be low, and if the average particle size is greater than about 100 nm, it may generate negative effects as well as positive effects.

When the SiO₂ solution is mixed with the respective red, green or blue phosphor material, the amount of SiO₂ mixed with the phosphor material may be in the range of about 0.01% to about 20% based on the phosphor material weight. More particularly, the amount of SiO₂ mixed with the phosphor material may be in the range of about 1% to about 10% based on the phosphor material weight. If the SiO₂ is used at less than 0.01 wt %, the resulting surface-treated phosphor material paste may not be sufficiently dispersed and may not adhere well to glass, negatively affecting the formation of the phosphor layer 18. If the SiO₂ is used at more than 20 wt %, the phosphor layer 18 formed from the surface-treated phosphor material may exhibit diminished brightness.

As described above, the phosphor material that is surface-treated with SiO₂ may include conventional red and blue phosphor materials such as Y₂O₂S:Eu, Y₂O₃:Eu, YVO₄:Eu, Y(V,P)O₄:Eu,(Y,Gd)BO₂:Eu, SrTiO₃:Pr and mixtures thereof for red, and SrGa₂S₄:Ce, ZnS:Ag, Y₂SiO₅:Ce, Sr₅(PO₄)₃Cl:Eu, ZnS:Ag, BaMgAl₁₀O₁₇:Eu and mixtures thereof for blue.

Moreover, the phosphor material that is surface-treated with SiO₂ may include conventional green phosphor materials as well as SrGa₂S₄:Eu. In contrast to the present invention, conventionally made electron emission display devices have not used SrGa₂S₄:Eu in green phosphor layers because the SrGa₂S₄:Eu phosphor material has been found to be inappropriate for the conventional light emission unit manufacturing process.

In particular, the conventional light emission unit manufacturing process uses spin coating. However, the SrGa₂S₄:Eu phosphor material reacts with the binder used in the spin coating process, impeding the spin coating process. In detail, the conventional spin coating process may include preparing a phosphor slurry including the red, green or blue phosphor material as well as several additives such as a photosensitive polymer, a photo cross-linking agent, a dispersing agent, etc., and spin coating the phosphor slurry across the entire surface of the substrate, including between the black layers. The coated phosphor slurry may then be dried, patterned with a mask by exposing it to light such as a high-pressure mercury lamp, and developed using, e.g., water.

It will be appreciated that the conventional spin coating process involves forming a first phosphor layer, e.g., one of a red, green or blue phosphor layer, and subsequently applying a phosphor slurry of one of the remaining phosphor colors on top of the first-formed phosphor layer. After patterning and developing the second phosphor slurry, the process is again repeated, such that the last phosphor slurry is applied on top of the first two phosphor layers. Accordingly, if the phosphor slurries react with or affect the earlier-formed phosphor layers, the order of formation of the phosphor layers becomes critical. For example, a red phosphor slurry may be spin coated on a blue phosphor layer and then needs to be removed completely from the blue phosphor layer. Moreover, the additives used in the phosphor slurries are constrained by the particular red, green or blue phosphor material used therein.

If the phosphor material is used without any additives or treatment, the phosphor material particles may not be well dispersed, resulting in the formation of many pin holes among the phosphor particles. Accordingly, phosphor materials have been surface treated to regulate the adherence characteristic among the phosphor material particles and to improve a lifespan thereof. For example, in the conventional spin coating process, a blue phosphor material may have a problem of remaining on green or red phosphor layers due to excessive adherence to itself when preparing a blue phosphor layer. Therefore, the blue phosphor material may be surface-treated with a material such as Ca₂P₂O₇ to slightly deteriorate adherence among the blue phosphor particles. However, in the conventional spin coating process, green or red phosphors should be surface-treated with a material such as SiO₂ to improve adherence among the phosphor material particles. Accordingly, in the conventional spin coating process using a slurry to form a phosphor layer, the phosphor materials may be surface-treated in different ways depending on the order of formation of the phosphor layers. This adds undesirable complexity to the manufacturing process.

In addition, the surface treatment materials in the spin coating slurry may be bound on the surface of the phosphor material particles by using a binder. For example, the red phosphor may need gum arabic as a binder, unlike the other phosphors. However, the gum arabic may cause slurry gelation, deteriorating its storage stability.

The electron emission display device and method of making the same according to the present invention allow for a same surface treatment to be applied to each of the different colors of phosphor materials, since the method according to the present invention can use direct pattern printing instead of spin-coating. That is, by employing pattern printing according to the present invention, each color of phosphor material, e.g., red, green and blue, may be surface-treated with a same material, such as SiO₂, because the respective surface-treated red, green and blue phosphor materials do not need to be applied on earlier-formed phosphor layers of another color and then removed. Thus, the surface treatments and printing order are not restricted as they are in the conventional process of spin coating a slurry. Accordingly, the present invention may advantageously simplify the manufacturing process and lower costs as compared with the conventional spin coating approach requiring surface treatment of the phosphors with different materials. Additionally, electron emission display device and method of making the same according to the present invention allow for SrGa₂S₄:Eu to be used as a green phosphor material.

An embodiment of the present invention will now be described in the context of a particular example. However, the present invention is not limited thereto.

A SiO₂ solution was prepared by mixing SiO₂ in water. Separate surface-treated red, green and blue phosphor materials were prepared by mixing the SiO₂ solution with red, green and blue phosphorous materials, respectively, and then adding ethyl cellulose binder to yield red, green and blue phosphor pastes, respectively. The red phosphor material used for the red phosphor paste was Y₂O₃:Eu, the green phosphor material used for the green phosphor paste was SrGa₂S₄:Eu and the blue phosphor material used for the blue phosphor paste was ZnS:Ag. The respective phosphor material pastes were selectively applied only at the final positions for the red, green and blue phosphor layers.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of making an electron emission display device having an electron emission unit and a light emission unit, wherein forming the light emission unit comprises:
forming a black layer pattern on a substrate;
printing a first phosphor pattern using a first phosphor paste;
printing a second phosphor pattern using a second phosphor paste; and
printing a third phosphor pattern using a third phosphor paste,
wherein the each of the first, second and third phosphor pastes includes, respectively, first, second and third phosphor materials that are surface-treated with a same surface treatment.

2. The method as claimed in claim 1, wherein the first phosphor paste is a red phosphor paste, the second phosphor paste is a green phosphor paste and the third phosphor paste is a blue phosphor paste.

3. The method as claimed in claim 1, wherein at least one phosphor material includes SrGa₂S₄:Eu.

4. The method as claimed in claim 1, wherein each of the first, second and third phosphor materials are surface-treated with SiO₂.

5. The method as claimed in claim 4, wherein the surface treatment includes:
preparing a SiO₂ solution from SiO₂ particles; and
mixing the SiO₂ solution with the respective phosphor material to form a mixture.

6. The method as claimed in claim 5, wherein the mixture includes a weight of SiO₂ in a range of about 0.01 to about 20%, based on the weight of the phosphor material in the mixture.

7. The method as claimed in claim 6, wherein the mixture includes a weight of SiO₂ in a range of about 1 to about 10%, based on the weight of the phosphor material in the mixture.

8. The method as claimed in claim 5, wherein the SiO₂ particles have an average particle size in a range of about 1 nm to about 100 nm.

9. The method as claimed in claim 1, wherein printing the first, second and third phosphor patterns includes applying the first, second and third phosphor pastes only in locations corresponding to respective first, second and third phosphor layers.

10. The method as claimed in claim 1, wherein the first, second and third phosphor patterns are printed using a print head.

11. The method as claimed in claim 1, wherein the black layer pattern includes a plurality of voids corresponding to pixel regions, and the first, second and third phosphor patterns are printed in the voids.

12. The method as claimed in claim 1, further comprising firing the phosphor patterns at a temperature in a range of about 400 ° C. to about 480° C.

13. A flat panel display panel, comprising:
an energy emission unit; and
a light emission unit disposed to face the energy emission unit, wherein the light emission unit includes:
a black layer pattern on a substrate;
a first phosphor pattern;
a second phosphor pattern; and
a third phosphor pattern,
wherein the each of the first, second and third phosphor patterns includes, respectively, first, second and third phosphor materials that are surface-treated with a same surface treatment.

14. The flat panel display panel as claimed in claim 13, wherein the first, second and third phosphor patterns are red, green and blue phosphor patterns, respectively.

15. The flat panel display panel as claimed in claim 13, wherein the energy emission unit is an electron emission unit.

16. The flat panel display panel as claimed in claim 13, wherein at least one phosphor pattern includes SrGa₂S₄:Eu.

17. The flat panel display panel as claimed in claim 13, wherein the first, second and third phosphor materials are surface-treated with SiO₂.

18. An electron emission display panel, comprising:
an electron emission unit; and
a light emission unit disposed to face the electron emission unit, wherein the light emission unit includes a SrGa₂S₄:Eu phosphor layer.

19. The electron emission display panel as claimed in claim 18, wherein the SrGa₂S₄:Eu phosphor layer includes SiO₂.
